(19) United States
(12) Patent Application Publication
(10) Pub. No.: US 2007/0049684 A1
(43) Pub. Date: Mar. 1, 2007

(54) Polyurethane-polyurea dispersions and their use as coating compositions

(75) Inventors: Thorsten Rische, Unna (DE); Holger Casselmann, Odenthal (DE); Thomas Feller, Solingen (DE); Harald Blum, Leverkusen (DE); Gerald Kurek, Leipzig (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/495,394

(22) Filed: Jul. 28, 2006

(30) Foreign Application Priority Data
Aug. 25, 2005 (DE) 10 2005 040 130.9

(51) Int. Cl. C08G 18/08

(52) U.S. Cl. 524/589; 428/423.1

(57) ABSTRACT

The present invention relates to aqueous polyurethane-polyurea dispersions wherein the dispersions contain polyurethane-polyureas that are the reaction products of I) polyisocyanates having an isocyanate group functionality of ≧2, II) a polymeric polyol component containing
a) 50% to 100% by weight, based on the weight of polyol component II), of polyester polyols having a number average molecular weight Mₙ of 200 to 8000 g/mol and synthesized from a hydroxyl component and an acid component wherein 50% to 100% by weight, based on the total weight of the hydroxyl component used to prepare polyester polyols II.a), are diols corresponding to formula 1), 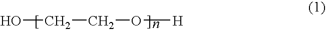 wherein n is 1 and/or 2, and b) 0% to 50% by weight, based on the weight of polyol component II), of polymeric polyols other than polyester polyols a), and III) optionally other isocyanate-reactive compounds. The present invention also relates to a process for preparing these aqueous dispersions, to coating compositions containing these aqueous dispersions and to substrates coated with these coating compositions, in particular leather and textile substrates.

### BACKGROUND OF THE INVENTION

1. Field of the Invention

The present invention relates to aqueous polyurethane-polyurea dispersions based on specific polyesters, to a process for their preparation and to substrates coated with these dispersions, in particular leather and textile substrates.

2. Description of Related Art

Substrates are increasingly being coated using aqueous binders, especially polyurethane-polyurea (PUR) dispersions. In contrast to many other classes of aqueous binders, PUR dispersions are notable in particular for high resistance to chemicals and water, high mechanical robustness, and a high tensile strength and elongation. These requirements are largely met by the polyurethane-polyurea dispersions of the prior art. The systems specified therein may, as a result of hydrophilic groups, be self-emulsifying, i.e., they may be dispersed in water without the aid of external emulsifiers. A disadvantage of the PUR dispersions of the prior art is that they do not always satisfy the requirements, which are becoming ever more exacting, for high tensile strength in combination with very high elongation.

It is an object of the present invention to provide improved polyurethane-polyurea (PUR) dispersions that are suitable for producing films combining high tensile strength with extreme elongation.

It is known that through the selection of the monomers used for preparing polyesters it is possible to exert a critical influence on their hardness, elasticity, and the impact resistance of coatings. Flexibilizing units include relatively long-chain, aliphatic compounds such as 1,6-hexanediol or adipic acid. Using short chain aliphatic or aromatic compounds such as ethylene glycol, propane-1,2-diol or phthalic acid leads to correspondingly hard, relatively non-elastic films and coatings.

It has now been found, surprisingly and contrary to the general teachings, that through the incorporation of specific polyester polyols, synthesized predominantly from short chain polyol components, it is possible to obtain PUR dispersions which exhibit very good elongation and thus overcome the disadvantages of the prior art.

### SUMMARY OF THE INVENTION

The present invention relates to aqueous polyurethane-polyurea dispersions wherein the dispersions contain polyurethane-polyureas that are the reaction products of
I) polyisocyanates having an isocyanate group functionality of ≧2,
II) a polymeric polyol component containing
a) 50% to 100% by weight, based on the weight of polyol component II), of polyester polyols having a number average molecular weight Mₙ of 200 to 8000 g/mol and synthesized from a hydroxyl component and an acid component wherein 50% to 100% by weight, based on the total weight of the hydroxyl component used to prepare polyester polyols II.a), are diols corresponding to formula 1), 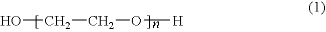
wherein
n is 1 and/or 2, and
b) 0% to 50% by weight, based on the weight of polyol component II), of polymeric polyols other than polyester polyols a),
III) optionally low molecular weight compounds having a molecular weight of 62 to 400 g/mol and containing in total two or more hydroxyl groups, amino groups or mixtures thereof,
IV) optionally compounds having one hydroxyl or amino group,
V) optionally isocyanate-reactive compounds containing ionic or potential ionic hydrophilic groups, and
VI) optionally isocyanate-reactive compounds containing nonionic hydrophilic groups.

The present invention also relates to a process for preparing these aqueous dispersions, to coating compositions containing these aqueous dispersions and to substrates coated with these coating compositions, in particular leather and textile substrates.

### DETAILED DESCRIPTION OF THE INVENTION

Suitable polyisocyanates I) are the aromatic, araliphatic, aliphatic or cycloaliphatic polyisocyanates which are known from polyurethane chemistry, preferably have an NCO functionality of ≧2, and may contain iminooxadiazinedione, isocyanurate, uretdione, urethane, allophanate, biuret, urea, oxadiazinetrione, oxazolidinone, acylurea and/or carbodiimide groups. They can be used individually or in any desired mixtures with one another.

Examples of suitable monomeric polyisocyanates include butylene diisocyanate, hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, isocyanatomethyl-1,8-octane diisocyanate, 1,4-cyclohexylene diisocyanate, 1,4-phenylene diisocyanate, 2,4- and/or 2,6-tolylene diisocyanate, 1,3- and 1,4-bis(2-isocyanatoprop-2-yl)benzene (TMXDI), 1,3-bis(isocyanatomethyl)benzene (XDI), 1,5-naphthylene diisocyanate, 2,4′- or 4,4′-diphenylmentane diisocyanate or triphenylmethane 4,4′,4″-triisocyanate. Also suitable are polyisocyanate adducts prepared from these monomeric polyisocyanates, having more than 2 NCO groups and containing uretdione, isocyanurate, urethane, allophanate, biuret, iminooxadiazinedione and/or oxadiazinetrione groups.

An example of a monomeric polyisocyanate having more than 2 NCO groups per molecule is 4-isocyanatomethyl-1,8-octane diisocyanate (nonane triisocyanate).

Preferred polyisocyanates or polyisocyanate mixtures are those containing exclusively aliphatically and/or cycloaliphatically bound isocyanate groups. Particularly preferred are hexamethylene diisocyanate, isophorone diisocyanate, the isomeric bis(4,4′-isocyanatocyclohexyl)methanes, and mixtures thereof.

In accordance with the invention polymeric polyol component II) contains at least one polyester polyol II.a) synthesized predominantly from the short chain diols of formula 1). Component II) may also contain polyols II.b). Examples of polyols II.b) include the known polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, polyester polycarbonate polyols, phenol/formaldehyde resins, or mixtures thereof. Polyols of this kind may also include, at least proportionally, primary or secondary amino groups as NCO-reactive groups.

Polyester polyols II.a) have a molecular weight Mₙ of 200 to 8000 g/mol, preferably 400 to 8000 g/mol and more preferably from 600 to 3000 g/mol; a hydroxyl number of 22 to 400 mg KOH/g, preferably 30 to 200 mg KOH/g and more preferably 40 to 160 mg KOH/g; and an OH functionality of 1.5 to 6, preferably of 1.8 to 3, more preferably of 1.8 to 2.2, and most preferably of 1.9 to 2.1.

Suitable polyester polyols II.a) include polycondensates of diols and optionally poly(tri, tetra)ols and dicarboxylic and optionally poly(tri, tetra)carboxylic acids or hydroxycarboxylic acids or lactones. Instead of the free polycarboxylic acids it is also possible to use the corresponding polycarboxylic anhydrides or corresponding polycarboxylic esters of lower alcohols to prepare the polyesters.

For preparing polyester polyols II.a) it is possible to use other diols or polyols in addition to the short chain diols of formula 1). Examples of other diols include butylene glycol, triethylene glycol, polyalkylene glycols such as polyethylene glycol, propanediol, butane-1,4-diol, hexane-1,6-diol, neopentyl glycol, preferably the last three compounds. Examples of other polyols include trimethylolpropane, glycerol, erythritol, pentaerythritol, trimethylolbenzene or tris-hydroxyethyl isocyanurate.

Suitable dicarboxylic or polycarboxylic acids include phthalic acid, isophthalic acid, terephthalic acid, tetrahydrophthalic acid, hexahydrophthalic acid, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid or dimer fatty acid with 20 to 50 carbon atoms. Anhydrides of these acids can also be used where they exist. As used herein anhydrides are encompassed by the expression “acid”.

Also suitable are monocarboxylic acids, such as saturated or unsaturated fatty acids having 10 to 20 carbon atoms, benzoic acid, 2-ethylhexanoic acid and hexanecarboxylic acid, provided that the average functionality of the polyol is higher than 2. Saturated aliphatic or aromatic acids are preferred, such as adipic acid and/or phthalic acid or phthalic anhydride. A suitable polycarboxylic acid, which may be used in relatively small amounts, is trimellitic acid.

Hydroxy carboxylic acids, which can be used as reactants in the preparation of a polyester polyol with terminal hydroxyl group, include hydroxycaproic acid, hydroxybutyric acid, hydroxydecanoic acid and hydroxystearic acid. Lactones which can be used include caprolactone and butyrolactone.

50 to 100%, preferably 50% to 99%, more preferably 55% to 75% and most preferably 58% to 70% by weight, of the diols used for preparing polyester polyols II.a) are selected from the ethylene glycols of formula 1) 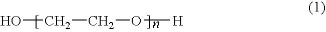
wherein n is 1 and/or 2.

These short chain polyols can be used in combination with other diols, preferably 1,4-butanediol and/or 1,6-hexanediol. Preferred acid components for preparing polyester polyols II.a) are adipic acid and/or phthalic acid. When 100% by weight of diol components of formula 1) are used to synthesize the polyester II.a), they are also preferably combined with adipic acid and/or phthalic acid components.

Polyols II.b) have a molecular weight Mₙ of 200 to 8000 g/mol, preferably 400 to 8000 g/mol and more preferably from 600 to 3000 g/mol; a hydroxyl number of 22 to 400 mg KOH/g, preferably 30 to 200 mg KOH/g and more preferably 40 to 160 mg KOH/g; and an OH functionality of 1.5 to 6, preferably of 1.8 to 3 and more preferably of 1.9 to 2.1. Preferred polyols II.b) are polyester polyols, polycarbonate polyols and polyether polyols.

Suitable polycarbonate polyols are those obtained by reacting carbonic acid derivatives (such as diphenyl carbonate or dimethyl carbonate or phosgene) with polyols, preferably diols. Suitable diols include ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A and lactone-modified diols.

The diol component preferably contains 40% to 100% by weight of hexanediol, preferably 1,6-hexanediol and/or hexanediol derivatives, preferably derivatives which have terminal OH groups and contain ether groups or ester groups. Examples are products obtained by reacting 1 mole of hexanediol with at least 1 mole, preferably 1 to 2 moles, of caprolactone or by etherifying hexanediol with itself to form the di- or trihexylene glycol. Polyether polycarbonate diols can also be used.

The polycarbonate polyols are preferably substantially linear. As a result of the incorporation of polyfunctional components, however, especially low molecular weight polyols, they may optionally contain a low degree of branching. Examples of compounds suitable for this purpose include glycerol, trimethylolpropane, hexane-1,2,6-triol, butane-1,2,4-triol, trimethylolpropane, pentaerythritol, quinitol, mannitol, sorbitol, methylglycoside or 1,3,4,6-dianhydrohexitols.

Suitable polyether polyols for use as polyols II.b) include the polytetramethylene glycol polyethers known from polyurethane chemistry, which may be prepared via polymerization of tetrahydrofuran by cationic ring opening.

Also suitable as polyols II.b) are polyethers prepared using starter molecules such as styrene oxide, ethylene oxide, propylene oxide, butylene oxides or epichlorohydrin, preferably propylene oxide.

The weight percent of components II.a) present in polyol component II), which contains components II.a) and II.b), is 50% to 100%, preferably 60% to 100% and more preferably 75% to 100% by weight.

The low molecular weight polyols III) used for synthesizing the polyurethane resins generally have the effect of stiffening and/or branching the polymer chain. The number average molecular weight is preferably 62 to 400. Suitable polyols III) contain aliphatic, alicyclic or aromatic groups. Examples include low molecular weight polyols having up to about 20 carbon atoms per molecule, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxycyclohexyl)propane), trimethylolpropane, glycerol, pentaerythritol, and mixtures of these and optionally other low molecular weight polyols III). Ester diols, such as α-hydroxybutyl-ε-hydroxycaproic esters, ω-hydroxyhexyl-γ-hydroxybutyric esters, adipic acid β-hydroxyethyl esters or terephthalic acid bis(β-hydroxyethyl)esters, can also be used.

Diamines, polyamines and also hydrazides can also be used as component III). Examples include ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylene-diamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic dihydrazide.

Also suitable as component III) are compounds which contain active hydrogen having different reactivity towards NCO groups, such as compounds which as well as one or more primary amino groups also contain one or more secondary amino groups or as well as one or more amino groups (primary or secondary) also contain one or more OH groups. Examples include primary/secondary amines, such as 3-amino-1-methylaminopropane, 3-amino-1-ethylaminopropane, 3-amino-1-cyclohexylaminopropane or 3-amino-1-methylaminobutane; and alkanolamines such as N-aminoethylethanolamine, ethanolamine, 3-aminopropanol, neopentanolamine and preferably diethanolamine. In the preparation of the PUR dispersion of the invention they can be used as chain extenders and/or as chain terminators.

The PUR dispersions of the invention may optionally contain component IV) which are in each case located at the chain ends and close off the ends. These units are derived from monofunctional compounds reactive with NCO groups, such as monoamines, especially mono-secondary amines, or monoalcohols. Examples include ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, and suitable substituted derivatives thereof; amide amines formed from diprimary amines and monocarboxylic acids; monoketimes of diprimary amines; and primary/tertiary amines, such as N,N-dimethylaminopropylamine.

Ionic or potential ionic hydrophilic compounds V) includle compounds which contain at least one isocyanate-reactive group and also at least one functionality, such as —COOY, —SO₃Y, —PO(OY)₂ (Y, for example, ═H, NH₄⁺, metal cation), —NR₂, —NR₃⁺(R═H, alkyl, aryl), which on interaction with aqueous media enters into a pH-dependent dissociation equilibrium and in that way may carry a negative, positive or neutral charge. Preferred isocyanate-reactive groups are hydroxyl or amino groups.

Suitable ionic or potential ionic hydrophilic compounds for use as component V) include mono- and dihydroxycarboxylic acids, mono- and diaminocarboxylic acids, mono- and dihydroxysulphonic acids, mono- and diaminosulphonic acids, mono- and dihydroxyphosphonic acids, mono- and diaminophosphonic acids and their salts. Examples include dimethylolpropionic acid, dimethylolbutyric acid, hydroxypivalic acid, N-(2-aminoethyl)-β-alanine, 2-(2-aminoethylamino)ethane sulphonic acid, ethylenediamine-propyl- or -butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal and/or ammonium salts, the adduct of sodium bisulphite with but-2-ene-1,4-diol, polyethersulphonate, the propoxylated adduct of 2-butenediol and NaHSO₃, described for example in DE-A 2 446 440 (page 5-9, formula I-III), and also compounds which contain units which can be converted into cationic groups, e.g., amine-based units, such as N-methyldiethanolamine. It is additionally possible to use cyclohexylaminopropanesulphonic acid (CAPS), for example, as in WO-A 01/88006, as component V).

Preferred ionic or potential ionic compounds V) are those which possess carboxyl, carboxylate, sulphonate groups or ammonium groups. Particularly preferred ionic compounds V) are those containing carboxyl and/or sulphonate groups as ionic or potentially ionic groups, such as the salts of N-(2-aminoethyl)-β-alanine, 2-(2-aminoethylamino)ethanesulphonic acid, the adduct of IPDI and acrylic acid (EP-A 0 916 647, Example 1), and dimethylolpropionic acid.

Suitable nonionic hydrophilic compounds for use as component VI) include polyoxyalkylene ethers which contain at least one hydroxyl or amino group. These polyethers contain 30% to 100% by weight of ethylene oxide units. Nonionic hydrophilic compounds VI) also include monofunctional polyalkylene oxide polyether alcohols containing on average 5 to 70, preferably 7 to 55, ethylene oxide units per molecule, and may be obtained in known manner by alkoxylating suitable starter molecules.

Examples of suitable starter molecules include saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-ethyl-3-hydroxymethyl-oxetane, tetrahydrofurfuryl alcohol, or diethylene glycol monoalkyl ethers such as diethylene glycol monobutyl ether; unsaturated alcohols such as allyl alcohol, 1,1-dimethylallyl alcohol or oleyl alcohol; aromatic alcohols such as phenol, the isomeric cresols or methoxyphenols; araliphatic alcohols such as benzyl alcohol, anisyl alcohol or cinnamyl alcohol; secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine; and also heterocyclic secondary amines such as morpholine, pyrrolidine, piperidine or 1H-pyrazole. Preferred starter molecules are saturated monoalcohols. Particularly preferred is diethylene glycol monobutyl ether.

Suitable alkylene oxides suitable for the alkoxylation reaction include, in particular, ethylene oxide and propylene oxide, which can be used in any order or as a mixture in the alkoxylation reaction.

The polyalkylene oxide polyether alcohols are either pure polyethylene oxide polyethers or mixed polyalkylene oxide polyethers in which at least 30 mol %, preferably at least 40 mol %, of the alkylene oxide units are ethylene oxide units. Preferred nonionic compounds are monofunctional mixed polyalkylene oxide polyethers which contain at least 40 mol % of ethylene oxide units and not more than 60 mol % of propylene oxide units.

The process for preparing the aqueous PUR dispersion of the invention can be carried out in one or more stages in a homogeneous phase or, in the case of a multi-stage reaction, partially in the dispersed phase. Following polyaddition of components I)-VI), which may be carried out completely or partially, there is a dispersing, emulsifying or dissolving step. Thereafter, optionally, there is a further polyaddition or modification in dispersed phase.

To prepare the aqueous PUR dispersions of the invention it is possible to use all of the methods known from the prior art, such as the prepolymer mixing method, acetone method or melt dispersing method. The PUR dispersions of the invention are prepared preferably by the acetone method.

The present invention also relates to a process for preparing the aqueous polyurethane-polyurea dispersions of the invention by reacting components I) to VI) to prepare an isocyanate-functional prepolymer free of urea groups at an equivalent ratio of isocyanate groups to isocyanate-reactive groups of 1.0 to 3.5, preferably 1.2 to 3.0 and more preferably 1.3 to 2.5. The amount of ionic or potential ionic groups is preferably 0.1 to 50 milliequivalents per 100 g of solid resin. Subsequently chain-extending or chain-terminating the remaining isocyanate groups with amino-functional compounds before, during or after dispersing in water. The equivalent ratio of isocyanate-reactive groups of the compounds used for chain extension or chain termination to free isocyanate groups of the prepolymer is 40% to 150%, preferably 50% to 120%, and more preferably 60% to 120%.

The PUR dispersions of the invention may also be prepared by the acetone method. To accelerate the isocyanate addition reaction it is possible to use the catalysts known in polyurethane chemistry. Preferred is dibutyltin dilaurate.

Suitable solvents include the known aliphatic, keto-functional solvents such as acetone or butanone, which can be added not only at the beginning of the preparation but also in portions later on. Acetone and butanone are preferred. Other solvents include xylene, toluene, cyclohexane, butyl acetate, methoxypropyl acetate, and other solvents with ether or ester units. After preparing the dispersions, the solvents may be distilled off in whole or in part, or may remain completely in the dispersion.

The preparation of the polyurethane prepolymers is accompanied or followed, if the starting molecules are not already neutralized, by the partial or complete formation of salts of the anionic or cationic hydrophilic groups. In the case of anionic groups, use is made of bases such as tertiary amines, e.g., trialkvlamines having 1 to 12, preferably 1 to 6, carbon atoms in each alkyl radical. Examples include trimethylamine, triethylamine, methyldiethylamine, tripropylamine, N-methylmorpholine, methyldiisopropyl-amine, ethyldiisopropyl amine and diisopropylethylamine. The alkyl radicals may also have hydroxyl groups, as in the case of dialkylmonoalkanolamines, alkyldialkanolamines and trialkanolamines. As neutralizing agents it is also possible to use inorganic bases, such as ammonia, sodium hydroxide and/or potassium hydroxide. Preferred are triethylamine, triethanolamine, dimethylethanolamine or diisopropylethylamine.

The molar amount of the bases 50% to 125%, preferably 70% to 100%, based on the moles of the anionic groups. In the case of cationic groups, dimethyl sulphates or succinic acid are used. Neutralization may also take place simultaneously with dispersing, with the dispersing water already containing the neutralizing agent.

Subsequently, in a further process step, if it has not taken place or has taken place only partially, the prepolymer obtained is dissolved using aliphatic ketones such as acetone or butanone.

Subsequently, NH₂-functional and/or NH-functional compounds are reacted with the remaining isocyanate groups. This chain extension/chain termination may be carried out either in solvent prior to dispersing, during dispersing, or after dispersing in water. Chain extension is preferably carried out prior to dispersing in water.

When chain extension is carried out using compounds corresponding to the definition of V) with NH₂ groups or NH groups, the prepolymers are preferably chain-extended before the dispersing operation.

The preparation of the PUR dispersion from the prepolymers takes place following chain extension. For that purpose the dissolved and chain-extended polyurethane polymer either is introduced into the dispersing water with strong shearing, such as vigorous stirring, or conversely the dispersing water is stirred into the prepolymer solutions. Preferably the water is introduced into the dissolved prepolymer.

The solvent still present in the dispersions after the dispersing step is usually subsequently removed by distillation. Its removal actually during dispersing is also possible.

The solids content of the PUR dispersion is between 20% to 70%, preferably 30% to 65% by weight.

The PUR dispersions of the invention may contain known additives such as antioxidants, light stabilizers, emulsifiers, defoamers, thickeners, fillers, plasticizers, pigments, carbon-black sols and silica sols, aluminium dispersions, clay dispersions and asbestos dispersions, flow control agents or thixotropic agents. Depending on the desired properties and intended use of the PUR dispersions of the invention it is possible for up to 70%, based on total dry matter content, of such fillers to be present in the end product.

The present invention also relates to coating compositions containing the polyurethane-polyurea dispersions of the invention.

For the use of the PUR dispersions of the invention as coating compositions, they are used either alone or in combination with other aqueous binders. These other aqueous binders include polyester, polyacrylate, polyepoxide or polyurethane polymers. A further possibility is that of combination with radiation-curable binders, as are described, for example, in EP-A-0 753 531. It is also possible to cut the PU dispersions of the invention with other anionic or nonionic dispersions, such as polyvinyl acetate, polyethylene, polystyrene, polybutadiene, polyvinyl chloride, polyacrylate and copolymer dispersions.

The present invention also relates to coated substrates prepared from the polyurethane-polyurea dispersions of the invention. The polyurethane-polyurea dispersions of the invention are also suitable for producing sizing compositions systems or adhesive systems.

Examples of suitable substrates include woven and non-woven textiles, leather, paper, hard fibers, straw, paperlike materials, wood, glass, plastics, ceramic, stone, concrete, bitumen, porcelain, metals or glass fibers. Preferred substrates are textiles, leather, plastics, metallic substrates and glass or carbon fibers, especially textiles and leather.

The PUR dispersions of the invention are stable, storable and transportable and can be processed at any desired subsequent point in time. They can be cured at relatively low temperatures of 120 to 150° C. within 2 to 3 minutes to give coatings which have, in particular, very good wet bond strengths.

Depending on the selected chemical composition and urethane group content, coatings having different properties are obtained. Thus it is possible to obtain soft tacky coats, thermoplastic and rubber-elastic products having a wide variety of hardnesses, up to and including glass-hard thermosets. The hydrophilicity of the products may also fluctuate within certain limits. The elastic products can be processed thermoplastically at relatively high temperatures of 100 to 180° C., for example, if they have not been chemically crosslinked.

On account of their excellent elongation in combination with high tensile strengths, the PUR-dispersions of the invention are particularly suitable for applications in the fields of textile coating and leather coating.

The invention is further illustrated but is not intended to be limited by the following examples in which all parts and percentages are by weight unless otherwise specified.

### EXAMPLES

Ingredients and Abbreviations Used:

Diaminosulphonate: NH₂—CH₂CH₂—NH—CH₂CH₂—SO₃Na (45% in water)

The solids contents were determined in accordance with DIN EN ISO 3251.

NCO contents, unless expressly stated otherwise, were determined volumetrically in accordance with DIN EN ISO 11909.

The properties of PUR dispersions were determined on free films produced as follows:

A film applicator containing two polished rolls, which can be set an exact distance apart, had a release paper inserted into it ahead of the back roll. The distance between the paper and the front roll is adjusted using a feeler gauge. This distance corresponded to the film thickness (wet) of the resulting coating, and was adjusted to the desired add-on of each coat. When two or more coats were applied, coating was carried out consecutively.

To apply the individual coats the products (aqueous formulations were adjusted beforehand to a viscosity of 4500 mPa·s by addition of ammonia/polyacrylic acid) were poured onto the nip between the paper and the front roll, the release paper was pulled away vertically downwards, and the corresponding film was formed on the paper. When two or more coats were applied, each individual coat was dried and the paper was reinserted.

The modulus at 100% elongation was determined in accordance with DIN 53504 on films >100 μm thick.

The average particle sizes (the figure reported is the number average) of the PUR dispersions were determined by means of laser correlation spectroscopy (instrument: Malvern Zetasizer 1000, Malvern Instr. Limited).

### Example 1

### Comparative Example

350.0 g of a difunctional polyester polyol based on adipic acid and 1,6-hexanediol (number average molecular weight 1700 g/mol, OH No. about 66 mg KOH/g solid) were heated to 65° C. Subsequently, at 65° C., 60.1 g of hexamethylene diisocyanate were added over the course of 5 minutes and the mixture was stirred at 100° C. until the theoretical NCO content of 3.2% was attained. The finished prepolymer was dissolved with 729.1 g of acetone at 50° C. and subsequently a solution of 3.5 g of ethylenediamine, 22.6 g of diaminosulphonate and 110.3 g of water was metered in over the course of 5 minutes. The subsequent stirring time was 15 minutes. Thereafter, over the course of 10 minutes, the product was dispersed by the addition of 513.0 g of water. The solvent was subsequently removed by vacuum distillation to give a storage stable PUR dispersion having a solids content of 40.1% and a particle size of 169 nm.

### Example 2

### According to the Invention

350.0 g of a difunctional polyester polyol based on adipic acid and monoethylene glycol, 1,4-butanediol and diethylene glycol (weight ratio of OH components: 27/40/33, number average molecular weight 2000 g/mol, OH No. about 56) were heated to 65° C. Subsequently, at 65° C., 52.6 g of hexamethylene diisocyanate were added over the course of 5 minutes and the mixture was stirred at 100° C. until the theoretical NCO content of 2.9% was attained. The finished prepolymer was dissolved with 486.5 g of acetone at 50° C. and subsequently a solution of 3.0 g of ethylenediamine, 19.8 g of diaminosulphonate and 78.8 g of water was metered in over the course of 5 minutes. The subsequent stirring time was 15 minutes. Thereafter, over the course of 10 minutes, the product was dispersed by the addition of 532.2 g of water. The solvent was subsequently removed by vacuum distillation to give a storage stable PUR dispersion having a solids content of 40.0% and a particle size of 171 nm.

### Example 3

### According to the Invention

350.0 g of a difunctional polyester polyol based on adipic acid, phthalic anhydride (weight ratio: 1/1) and monoethylene glycol (number average molecular weight 1750 g/mol, OH No. 66) were heated to 65° C. Subsequently, at 65° C., 60.1 g of hexamethylene diisocyanate were added over the course of 5 minutes and the mixture was stirred at 100° C. until the theoretical NCO content of 3.2% was attained. The finished prepolymer was dissolved with 729.1 g of acetone at 50° C. and subsequently a solution of 3.5 g of ethylenediamine, 22.6 g of diaminosulphonate and 110.3 g of water was metered in over the course of 5 minutes The subsequent stirring time was 15 minutes. Thereafter, over the course of 10 minutes, the product was dispersed by the addition of 513.0 g of water. The solvent was subsequently removed by vacuum distillation to give a storage stable PUR dispersion having a solids content of 40.0% and a particle size of 187 nm.

### Example 4

### According to the Invention

306.3 g of a difunctional polyester polyol based on adipic acid and monoethylene glycol, 1,4-butanediol and diethylene glycol (weight ratio of OH components: 27/40/33, number average molecular weight 2000 g/mol, OH No. 56) and 43.8 g of a difunctional polyoxyethylene polyether (number average molecular weight 2000 g/mol, OH No. 56) were heated to 65° C. Subsequently, at 65° C., 52.6 g of hexamethylene diisocyanate were added over the course of 5 minutes and the mixture was stirred at 100° C. until the theoretical NCO content of 2.9% was attained. The finished prepolymer was dissolved with 715.8 g of acetone at 50° C. and subsequently a solution of 3.0 g of ethylenediamine, 19.8 g of diaminosulphonate and 76.6 g of water was metered in over the course of 5 minutes. The subsequent stirring time was 15 minutes. Thereafter, over the course of 10 minutes, the product was dispersed by the addition of 734.3 g of water. The solvent was subsequently removed by vacuum distillation to give a storage stable PUR dispersion having a solids content of 30.0% and a particle size of 179 nm.

### Example 5

### Comparative: n=1 and 2 (21% by Weight Monoethylene Glycol, 24% by Weight Diethylene Glycol)

350.0 g of a difunctional polyester polyol based on adipic acid and monoethylene glycol, 1,4-butanediol and diethylene glycol (weight ratio of OH components: 21/55/24, number average molecular weight 2000 g/mol, OH No. about 56) were heated to 65° C. Subsequently, at 65° C., 52.6 g of hexamethylene diisocyanate were added over the course of 5 minutes and the mixture was stirred at 100° C. until the theoretical NCO content of 2.9% was attained. The finished prepolymer was dissolved with 486.5 g of acetone at 50° C. and subsequently a solution of 3.0 g of ethylenediamine, 19.8 g of diaminosulphonate and 78.8 g of water was metered in over the course of 5 minutes. The subsequent stirring time was 15 minutes. Thereafter, over the course of 10 minutes, the product was dispersed by the addition of 532.2 g of water. The solvent was subsequently removed by vacuum distillation to give a storage stable PUR dispersion having a solids content of 39.7% and a particle size of 195 nm.

### Example 6

### Comparative: n=3

350.0 g of a difunctional polyester polyol based on adipic acid and 1,4-butanediol and triethylene glycol (weight ratio of OH components: 50/50, number average molecular weight 2000 g/mol, OH No. about 56) were heated to 65° C. Subsequently, at 65° C., 52.6 g of hexamethylene diisocyanate were added over the course of 5 minutes and the mixture was stirred at 100° C. until the theoretical NCO content of 2.9% was attained. The finished prepolymer was dissolved with 486.5 g of acetone at 50° C. and subsequently a solution of 3.0 g of ethylenediamine, 19.8 g of diaminosulphonate and 78.8 g of water was metered in over the course of 5 minutes. The subsequent stirring time was 15 minutes. Thereafter, over the course of 10 minutes, the product was dispersed by the addition of 532.2 g of water. The solvent was subsequently removed by vacuum distillation to give a storage stable PUR dispersion having a solids content of 40.7% and a particle size of 227 nm.

### Example 7

### Comparative n=4

350.0 g of a difunctional polyester polyol based on adipic acid and 1,4-butanediol and tetraethylene glycol (weight ratio of OH components: 25/75, number average molecular weight 2000 g/mol, OH No. about 56) were heated to 65° C. Subsequently, at 65° C., 52.6 g of hexamethylene diisocyanate were added over the course of 5 minutes and the mixture was stirred at 100° C. until the theoretical NCO content of 2.9% was attained. The finished prepolymer was dissolved with 486.5 g of acetone at 50° C. and subsequently a solution of 3.0 g of ethylenediamine, 19.8 g of diaminosulphonate and 78.8 g of water was metered in over the course of 5 minutes. The subsequent stirring time was 15 minutes. Thereafter, over the course of 10 minutes, the product was dispersed by the addition of 532.2 g of water. The solvent was subsequently removed by vacuum distillation to give a storage stable PUR dispersion having a solids content of 38.9% and a particle size of 158 nm.

### Example 8

### Comparative: IIa)/IIb)=45/55

157.5 g of a difunctional polyester polyol based on adipic acid, phthalic anhydride (weight ratio: 1.1) and monoethylene glycol, (number average molecular weight 1750 g/mol, OH No. 66) and 192.5 g of a difunctional polyester polyol based on adipic acid and hexanediol (number average molecular weight 1700 g/mol, OH No. about 66 mg) were heated to 65° C. Subsequently, at 65° C., 60.1 g of hexamethylene diisocyanate were added over the course of 5 minutes and the mixture was stirred at 100° C. until the theoretical NCO content of 3.2% was attained. The finished prepolymer was dissolved with 729.1 g of acetone at 50° C. and subsequently a solution of 3.5 g of ethylenediamine, 22.6 g of diaminosulphonate and 110.3 g of water was metered in over the course of 5 minutes. The subsequent stirring time was 15 minutes. Thereafter, over the course of 10 minutes, the product was dispersed by the addition of 513.0 g of water. The solvent was subsequently removed by vacuum distillation to give a storage stable PUR dispersion having a solids content of 39.4% and a particle size of 258 nm.

TABLE 1
Mechanical properties

| | | Tensile | Breaking |
|---|---|---|---|
| | 100% modulus | strength | elongation |
| Example | [MPa] | [MPa] | [%] |
| 1 (comparative) | 2.0 | 20.0 | 980 |
| 2 (inventive) | 1.6 | 24.6 | 1840 |
| 3 (inventive) | 1.7 | 20.7 | 1740 |
| 4 (inventive) | 3.0 | 37.2 | 1470 |
| 5 (comparative) | 2.5 | 19.2 | 910 |
| 6 (comparative) | 2.1 | 24.9 | 840 |
| 7 (comparative) | 1.9 | 18.0 | 950 |
| 8 (comparative) | 2.4 | 26.8 | 1020 |

As is apparent from Table 1, the coatings produced from the PUR dispersions of the invention exhibit comparable hardness and tensile strength but substantially higher elongations when compared to the comparison coatings.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane-polyurea dispersion wherein the dispersion contains polyurethane-polyureas that comprise the reaction product of
I) a polyisocyanate having an isocyanate group functionality of ≧2,
II) a polymeric polyol component comprising
a) 50% to 100% by weight, based on the weight of polyol component II), of a polyester polyol having a number average molecular weight Mₙ of 200 to 8000 g/mol and synthesized from a hydroxyl component and an acid component wherein 50% to 100% by weight, based on the total weight of the hydroxyl component used to prepare polyester polyol II.a), are diols corresponding to formula 1), 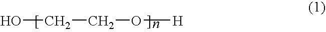
wherein
n is 1 and/or 2, and
b) 0% to 50% by weight, based on the weight of polyol component II), of a polymeric polyol other than polyester polyol a),
III) optionally a low molecular weight compound having a molecular weight of 62 to 400 g/mol and containing in total two or more hydroxyl groups, amino groups or mixtures thereof,
IV) optionally a compound having one hydroxyl or amino group,
V) optionally an isocyanate-reactive compound containing ionic or potential ionic hydrophilic groups, and
VI) optionally an isocyanate-reactive compound containing nonionic hydrophilic groups.

2. The aqueous dispersion of claim 1 wherein the polyester polyol is synthesized from 100% by weight, based on the total weight of diols used to prepare polyester polyol II.a), of diols corresponding to formula 1).

3. The aqueous dispersion of claim 1 wherein a portion of the hydroxyl component used to synthesize polyester polyol a) comprises 1,4-butanediol and/or 1,6-hexanediol.

4. The aqueous dispersion of claim 1 wherein a portion of the acid component used to synthesize the polyester polyol a) comprises adipic acid and/or phthalic acid.

5. The aqueous dispersion of claim 2 wherein a portion of the acid component used to synthesize the polyester polyol comprises adipic acid and/or phthalic acid.

6. The aqueous dispersion of claim 3 wherein a portion of the acid component used to synthesize the polyester polyol comprises adipic acid and/or phthalic acid.

7. The aqueous dispersion of claim 1 wherein polyol component II.b) is present and comprises a polyester, polycarbonate or polyether diol.

8. The aqueous dispersion of claim 2 wherein polyol component II.b) is present and comprises a polyester, polycarbonate or polyether diol.

9. The aqueous dispersion of claim 3 wherein polyol component II.b) is present and comprises a polyester, polycarbonate or polyether diol.

10. The aqueous dispersion of claim 4 wherein polyol component II.b) is present and comprises a polyester, polycarbonate or polyether diol.

11. The aqueous dispersion of claim 5 wherein polyol component II.b) is present and comprises a polyester, polycarbonate or polyether diol.

12. The aqueous dispersion of claim 6 wherein polyol component II.b) is present and comprises a polyester, polycarbonate or polyether diol.

13. A process for preparing the aqueous dispersion of claim 1 which comprises
a) initially reacting components (I) to (VI) at an equivalent ratio of isocyanate groups to isocyanate-reactive groups of 1.0 to 3.5 to prepare an isocyanate-functional prepolymer which is free of urea groups and contains 0.1 to 50 milliequivalents, per 100 g of solid resin, ionic or potential ionic groups and
b) subsequently chain-extending or chain-terminating the remaining isocyanate groups before, during or after dispersing in water with amino-functional compounds at an equivalent ratio of amino groups of the compounds used for chain extension or chain termination to free isocyanate groups of the prepolymer of 40% to 150%.

14. A coating composition comprising the aqueous polyurethane-polyurea dispersion of claim 1.

15. A coated substrate that is coated with the coating composition of claim 14.

16. A coated leather or textile substrate that is coated with the coating composition of claim 14.
